(19) United States
(12) Patent Application Publication
(10) Pub. No.: US 2010/0112300 A1
(43) Pub. Date: May 6, 2010

(54) PHOTOCURABLE MATERIALS with MICROFLUIDIC ENDOSKELETON

(75) Inventors: Orlin D. Velev, Cary, NC (US); Frederick J. Renk, Raleigh, NC (US); Suk Tai Chang, Seoul (KR); Garrett Swindlehurst, St. Paul, MN (US); Robert Odell Bradley, IV, Greensboro, NC (US)

Correspondence Address: MEADWESTVACO CORPORATION;ATTN: IP LEGAL DEPARTMENT, 1021 MAIN CAMPUS DRIVE, RALEIGH, NC, 27606, US

(73) Assignee: MEAD WESTVACO CORPORATION, Glen Allen, VA (US)

(21) Appl. No.: 12/613,092

(22) Filed: Nov. 5, 2009

Related U.S. Application Data
(60) Provisional application No. 61/111,368, filed on Nov. 5, 2008.

(51) Int. Cl. B32B 3/00; B32B 37/00

(52) U.S. Cl. 428/173; 156/60; 156/275.5

(57) ABSTRACT

A photocurable material having a microfluidic endoskeleton constructed in a flexible polymeric slab is disclosed. The flexible polymeric slab comprises a first flexible polymeric sheet with microchannel network embedded thereon and a second flexible polymeric sheet sealed to the first flexible polymeric sheet. The microchannel network is filled with a photocurable fluid that may be solidified upon exposure to an activated light to create a rigid endoskeleton within the slab. The flexible polymeric sheet may be polydimethylsiloxane (PDMS). The process allows preserving a user-defined shape by illumination of the material. The disclosed photocured shaped PDMS slab with microfluidic skeleton has enhanced tensile stress-strain properties, elastomeric modulus and bending modulus compared to the PDMS slab without the photocured microfluidic skeleton.

This non-provisional application relies on the filing date of provisional U.S. Application Ser. No. 61/111,368 filed on Nov. 5, 2008, having been filed within twelve (12) months thereof, which is incorporated herein by reference, and priority thereto is claimed under 35 USC §1.19(e).

### BACKGROUND OF THE DISCLOSURE

Microfluidics is a relatively new but rapidly developing technology in several areas such as biosensing, displays, nanoparticle synthesis, and biomedical applications. Microfluidic system typically consists of a plurality of microchannels and chambers etched or molded in a substrate such as silicon, quarts, glass, and plastic. The size, shape, and complexity of these microchannels and their interconnections influence the limits of a microsystem's functionality and capabilities.

U.S. Pat. No. 5,885,470 discloses a microfluidic system useful for chemistry, biotechnology, and molecular biology application, wherein the microchannels and chambers are formed in a polymeric substrate by wet chemical etching, photolithographic techniques, controlled vapor deposition, and laser drilling. U.S. Pat. No. 6,645,432 teaches a microfluidic system for biotechnology applications that includes complicated three-dimensionally arrayed channel networks. The microfluidic networks are fabricated via replica molding processes, utilizing mold masters that include surfaces having topological features formed by photolithography.

One of the most promising, yet virtually unexplored, areas for microfluidic system is the fabrication of materials with embedded microchannel networks, where the flow, pressure, temperature, color, and other properties of the liquid inside the channels impart certain functions or characteristics to the material in which the microchannel network is embedded. Broadly relevant functionalities have been used by nature in animal skin and tissue and plant tissue.

### SUMMARY OF THE DISCLOSURE

A photocurable material having a microfluidic endoskeleton constructed in a flexible polymeric slab is disclosed. The flexible polymeric slab comprises a first flexible polymeric sheet with microchannel network embedded thereon and a second flexible polymeric sheet sealed to the first flexible polymeric sheet. The microchannel network is filled with a photocurable fluid that may be solidified upon exposure to light or other radiation to create a rigid endoskeleton within the slab. The flexible polymeric sheet may be polydimethylsiloxane (PDMS). The process allows preserving a user-defined shape by illumination of the material. The disclosed PDMS slab with microfluidic skeleton after being photocured has enhanced tensile stress-strain properties, elastomeric modulus and bending modulus compared to the PDMS slab without the photocured microfluidic skeleton.

### BRIEF DESCRIPTION OF THE DRAWINGS

FIG. 1 is a flowchart describing one embodiment of the process of preparing the disclosed photocurable materials with microfluidic endoskeleton;

FIG. 2 illustrates one embodiment of the method of preparing the disclosed photocurable materials with microfluidic endoskeleton;

FIG. 3A shows a first polydimethylsiloxane (PDMS) sheet having a microchannel network embedded thereon;

FIG. 3B shows a second polydimethylsiloxane (PDMS) sheet having a microchannel network embedded thereon;

FIG. 4 is a graph showing the tensile stress-strain properties of three different PDMS slab samples: Control PDMS sample, and PDMS/SU-8 composite slabs having SU-8 fluid volume fractions of 0.108 and 0.185;

FIG. 5 is a graph showing the elastic modulus of the PDMS/SU-8 composite slabs as a function of the volume fraction of the SU-8 photoresist in the slab; and

FIG. 6 is a graph showing the bending modulus of the PDMS/SU-8 composite slabs as a function of the volume fraction of the SU-8 photoresist in the slab.

### DESCRIPTION OF THE DISCLOSURE

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof.

A photocurable microfluidic material of the present disclosure comprises:
(a) a flexible polymeric slab, including:
   (i) a first flexible polymeric sheet embedded with microchannel network embedded thereon;
   (ii) a second flexible polymeric sheet sealed to the first flexible polymeric sheet; and
(b) a photocurable fluid material in the microchannel network, the fluid being solidified upon exposure to an activated light to create a rigid endoskeleton within the slab.

In one embodiment of the present disclosure, the second flexible polymeric sheet is also embedded with microchannel network.

In one embodiment of the present disclosure where the second flexible polymeric sheet is also embedded with the microchannel network, the second flexible polymeric sheet is sealed to the first flexible polymeric sheet such that the microchannel networks embedded in the first and second flexible polymeric sheets are in an orthogonal orientation to each other.

When desired, more than two flexible polymeric sheets may be used in the formation of the disclosed photocurable microfluidic material. Although the illustrative examples consist of two flexible polymeric sheets, one skilled in the arts would appreciate that more than two flexible polymeric sheets may be used.

A variety of flexible polymers may be used for the slab of the disclosed photocurable materials. One example of such flexible polymers is polydimethyl-siloxane (PDMS). When desired, the first and second flexible polymeric sheets may be prepared from the same type of polymer.

In one embodiment of the present disclosure, the photocurable material comprises:
(a) a polydimethylsiloxane (PDMS) slab, including:
   (i) a first polydimethylsiloxane (PDMS) sheet with a microchannel network embedded thereon;
   (ii) a second polydimethylsiloxane (PDMS) sheet sealed to the first polydimethylsiloxane sheet; and
(b) a photocurable fluid material in the microchannel network, the fluid being solidified upon exposure to light to create a rigid endoskeleton within the slab.

Various photocurable fluidic materials may be used in the present disclosure. Examples of these polymers include, but are not limited to, epoxy prepolymer, epoxy-based polymers such as SU-8 polymer available from Norland Optical Adhesives (NOA), phenol formaldehyde polymers such as DNQ-Novolac photoresist, polyhydroxystyrene-based polymers, and dental-type polymers.

In one embodiment of the present disclosure, the activatable material comprises:
(a) a flexible polymeric slab, including:
   (i) a first flexible polymeric sheet embedded with microchannel network embedded thereon;
   (ii) a second flexible polymeric sheet sealed to the first flexible polymeric sheet; and
(b) an activated-curable fluid material in the microchannel network, the fluid being solidified upon application of external stimuli to create a rigid endoskeleton within the slab.

Examples of the stimulus-curable fluids suitable for use in the present disclosure may include, but are not limited to electrorheologic, magnetorheologic, thermoplastic, and thermoset polymeric materials, and the external stimuli may be heat, electric or magnetic field.

The disclosed photocurable material may be formed into a flexible sheet, shaped into desired structure or wrapped around packaged goods, and then exposed to an activating light to solidify “on demand” the photocurable fluid materials in the microchannel networks embedded in the PDMS slab. The photocured and solidified materials in the microchannel network act as an endoskeleton for the PDMS slab that preserves the desired structure and imparts enhanced mechanical properties such as elastic modulus.

The bending and stretching moduli of the disclosed photocured materials increase drastically once the fluid in the endoskeleton networks is solidified such that upon removal of the applied external stress, the “memorized” shapes are recovered. The permanent preservation of the shape of solidified microfluidic sheets may be used, for instance, in packaging applications to create “exoskeletons” for package contents or to create various containers on demand. The disclosed photocurable materials may also be used in materials for quick surface repairs, in rapid construction of industrial prototypes, and others.

The method of producing a photocurable material with microfluidic endoskeleton of the present disclosure comprises steps of:
(a) providing on a first flexible polymeric sheet embedded with microfluidic channel network;
(b) providing on a second flexible polymeric sheet;
(c) bonding the first flexible polymeric sheet with the second flexible polymeric sheet to provide a flexible polymeric slab including a microfluidic channel network; and
(d) introducing a photocurable fluid into the microfluidic channel network of the flexible polymeric slab.

In one embodiment of the disclosed method, the second flexible polymeric sheet is also embedded with microchannel network.

In one embodiment of the disclosed method where the second flexible polymeric sheet is also embedded with the microchannel network, the second flexible polymeric sheet is bonded to the first flexible polymeric sheet such that the microchannel networks embedded in the first and second flexible polymeric sheets are in diagonal direction to each other.

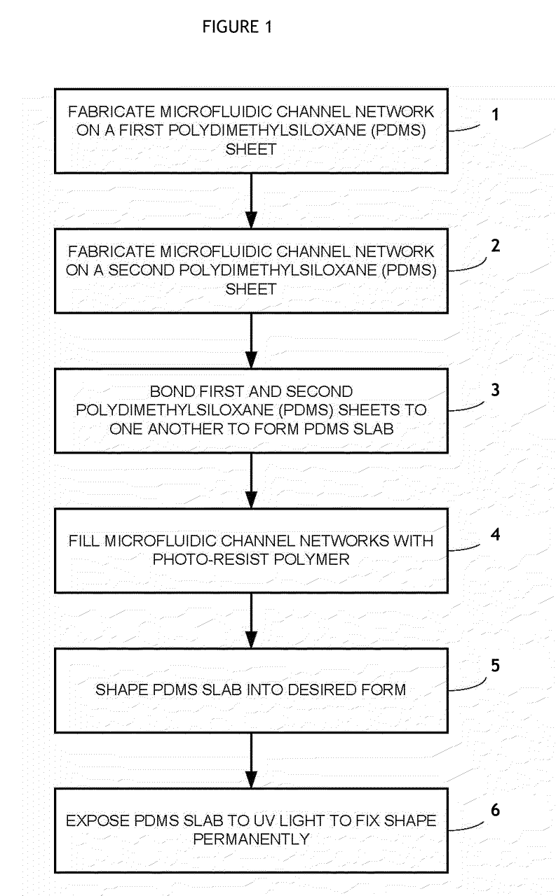

FIG. 1 is a flowchart of one embodiment of the disclosed method of preparing the photocurable materials with microfluidic endoskeleton, wherein the first and second flexible polymeric sheets are polydimethylsiloxane (PDMS) sheet embedded with microfluidic channel networks. One skilled in the art, however, appreciates that other types of flexible polymeric sheet may be used in the present disclosure and more layers of flexible, channel-bearing materials might be added.

In the steps 1 and 2 of FIG. 1, polydimethylsiloxane (PDMS) sheet having microfluidic channel network may be fabricated by various techniques. For example, the microfluidic channel networks in the PDMS sheet may be formed using soft lithography technique.

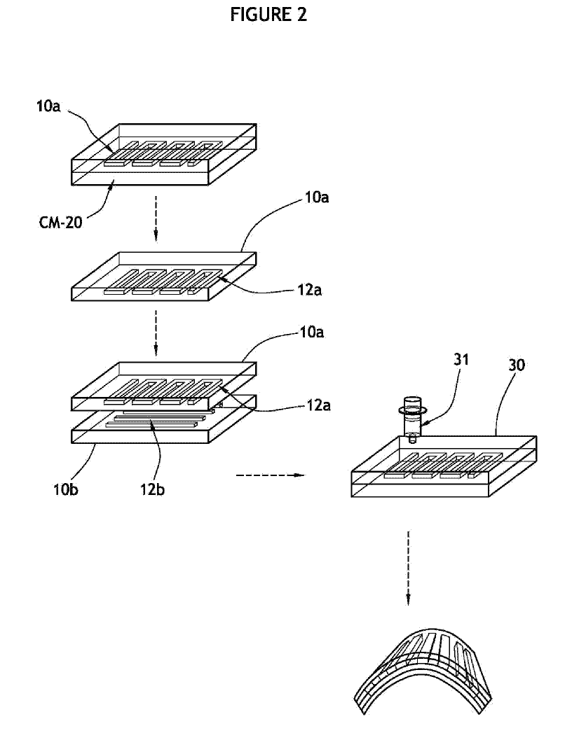

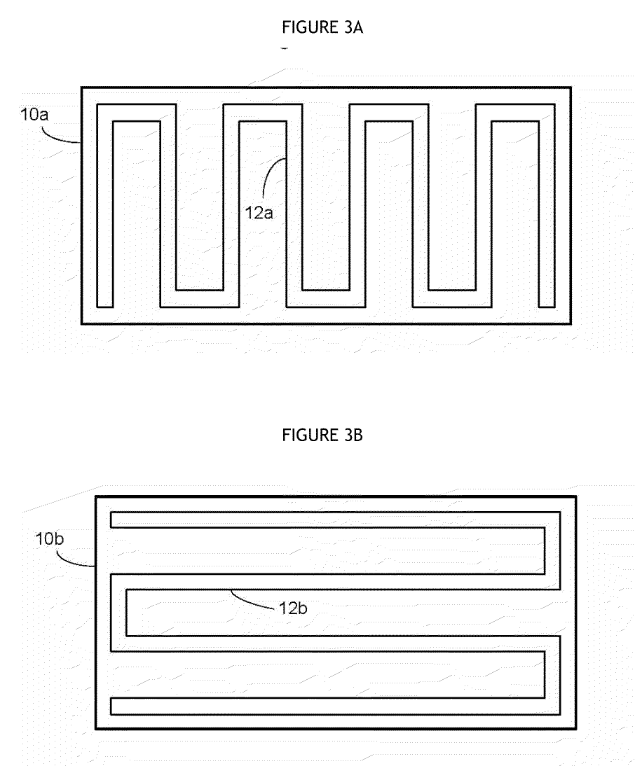

FIG. 2 illustrates one embodiment of the method of fabricating the flexible polymeric sheet with microfluidic channel network, wherein polydimethylsiloxane (PDMS) sheet is a flexible sheet. It is to be understood that other types of flexible polymeric sheet may be used in the present disclosure. A channel master (CM-20) is created by coating photocurable resin on a silicon wafer, and then placing transparency photomasks containing microfluidic channel designs on the surface on the photocurable coating. The assembled structure is then subjected to UV light exposure, solar radiation, or some other intense light source to actuate the curing of photocurable resin. After a post-baking, the UV exposed wafers are treated in an SU-8 developer solution and hard-baked to provide the channel master CM-20. The PDMS precursor is then cast on the channel master CM-20 and cured at about 70° C. to provide a PDMS layer (10a) positioning over the master CM-20. The resulting PDMS layer 10a is removed from the channel master CM-20 to provide a PDMS sheet 10a containing a microfluidic channel network 12a. FIG. 3A is a schematic diagram of the PMDS sheet 10(a). The PDMS sheet 10b containing microfluidic channel network 12b, as shown in FIG. 3B, may be prepared in the same matter. Two holes may be punched at each end of the channel networks using a sixteen-gauge needle.

In the step 3 of FIG. 1, the first and second PMDS sheets embedded with the channel networks are bonded to each other to form a PDMS slab. A variety of techniques may be used to bond the PDMS sheets and seal the resulting PDMS slab. One example of such techniques is an air-plasma cleaner.

As shown in FIG. 2, when desired, the PDMS sheets 10a and 10b may be bonded to one another to form the PDMS slab 30, such that the channel network 12a in the PDMS sheet 10a and the channel network 12b in the PDMS sheet 10b are in an orthogonal orientation.

In the step 4 of FIG. 1, the microfluidic channel network embedded in the resulting PDMS slab is filled with photocurable fluid. As shown in FIG. 2, the photocurable fluid 31 may be injected into the microfluidic channel of the PDMS slab 30 through the punched holes using a syringe. Example of the photocurable fluid suitable for use in the present disclosure may include, but are not limited to, liquid SU-8 25 polymer. When desired, the filling may be done on a hotplate at a temperature of about 55° C. to lower viscosity and improve SU-8 wettability to PDMS. Subsequently, the punched holes are then closed with a PDMS pre-polymer and cured at a temperature of about 70° C. to provide a sealed PMDS slab with embedded microfluidic channel network filled with photocurable fluid.

The resulting PMDS slab with its embedded microfluidic channel network filled with photocurable fluid possesses unique features; the most notable being the ability to adopt and retain a certain user-defined shape upon an on-demand exposure to an activated light. Additionally, the disclosed PMDS slab with photocurable endoskeleton retains the elastomeric characteristic of PMDS material. For example, the PDMS slab with microchannel networks filled with SU-8 prepolymer is transparent, soft and easily bent—similarly to the original silicon rubber. The disclosed photocurable material with photocurable endoskeleton may be formed into a variety of shapes, e.g. wavy, spiral, saddle, and pocket. (Step 5, of FIG. 1)

Upon exposure the resulting shaped material to a light or other radiation, the photocurable fluid in the microfluidic channel endoskeleton may be solidified and the desired shape is retained permanently. For example, the disclosed photocurable material may be exposed to UV light for about 5 minutes.

The disclosed photocured PDMS slab retain the defined deformation, yet remains soft and flexible on the surface. The photocured microfluidic network in the PDMS may be stretched, bent or twisted manually with high recoverable strain. The elastic moduli of the disclosed materials are dramatically increased upon exposure to an activating light.

The permanent preservation of the shape of the photocured materials of the present disclosure allows their use in making instant packages and supports on demand, creating “exoskeletons” for delicate package contents and multiple other applications. The disclosed materials may be used for covering or protecting brittle objects and easily scratchable surfaces.

The disclosed photocurable materials and their disclosed process of preparation are readily available, inexpensive, and scalable. The disclosed photocurable materials may be used for packaging or protecting arbitrary shaped objects and surfaces. The high flexibility of the disclosed materials enables users to wrap them around any arbitrary shape objects, and these objects may be protected after the disclosed materials are exposed to an activating light to solidify the photocurable fluid in the microchannels and subsequently preserve the shape.

### EXAMPLES

Production of PDMS Sheets Having Microfluidic Channel Network

The microfluidic channel networks inside the PDMS sheet were fabricated using soft lithography. Channel masters were created by coating an epoxy-based negative photoresist SU-8 2050 (available from MicroChem, Inc.) on a silicon wafer to a thickness of about 165 μm using a spin-coater Model P6700 available from Specialty Coating Systems, Inc. The transparency photomasks containing channel designs were brought into contact with the SU-8 photoresist, and the resulting assembly was selectively exposed to UV light generated from the BLAL-RAY® B-100A high powered UV lamp. After a post-baking, the UV exposed wafers were treated in SU-8 developer solution (available from MicroChem, Inc.) and hard-baked to generate the master channels.

A first PDMS sheet containing a microfluidic channel network was prepared by casting a PDMS precursor, SYLGARD 184 available from Dow Corning, on a first channel master and curing the precursor at about 70° C. to provide a PDMS layer over the channel master. The resulting PDMS layer was then peeled off the channel master to provide a first PDMS sheet containing a microfluidic channel network. Then, two holes were punched at each end of the channel a blunt 16 gauge needle.

A second PDMS sheet containing a microfluidic channel network was prepared by casting a PDMS precursor, SYLGARD 184 available from Dow Corning, on a second channel master and curing the precursor at about 70° C. to provide a PDMS layer over the channel master. The resulting PDMS layer was then peeled off the channel master to provide a second PDMS sheet containing a microfluidic channel network. Then, two holes were punched at each end of the channel using a blunt 16 gauge needle.

Production of the PDMS Slab Having the Embedded Microfluidic Channel Network Filled with Photocurable Fluid

The first and second PMDS sheets were irreversibly sealed to each other with orthogonal orientation of the channels using air-plasma cleaner Model PDC-32G available from Harrick Plasma. An epoxy-based photoresist SU-8 25 liquid (available from MicroChem, Inc.) was injected into the microchannel of the PDMS slab using a syringe. The filling was done on a hotplate at 55° C. to lower viscosity and improve wettability of the SU-8 25 liquid to PDMS. Subsequently, the punched holes were closed with PDMS precursor and cured at 70° C. to provide a sealed PMDS slab with embedded microfluidic channel network filled with photocurable SU-8 25 fluid.

Tensile Stress-Stain Study

The tensile stress-stain study was performed using a computer-controlled MTS mechanical testing system. A PMDS slab produced by bonding the first and second PDMS sheets together, but without filling the channel networks with photocurable fluid, was used as a control PMDS slab (“PDMS”).

Two PDMS slabs with embedded microfluidic channel network filled with photocurable SU-8 25 fluid (“PDMS/SU-8 composite”) were prepared having different SU-8 fluid volume fractions: 0.108 and 0.185. The difference in volume fraction of the SU-8 photoresist in PDMS/SU-8 composite slab was achieved by reducing the thickness of PDMS layer. Each PDMS/SU-8 composite sample was exposed to UV light for about 5 minutes to solidify the SU-8 photocurable fluid in the microfluidic channel network. The resulting photocured PDMS/SU-8 composite slabs were tested for tension properties, in comparison that of the control PMDS slab. The samples tested were of dimension 24 mm width by 35 mm length with various thicknesses (0.91-1.56 mm).

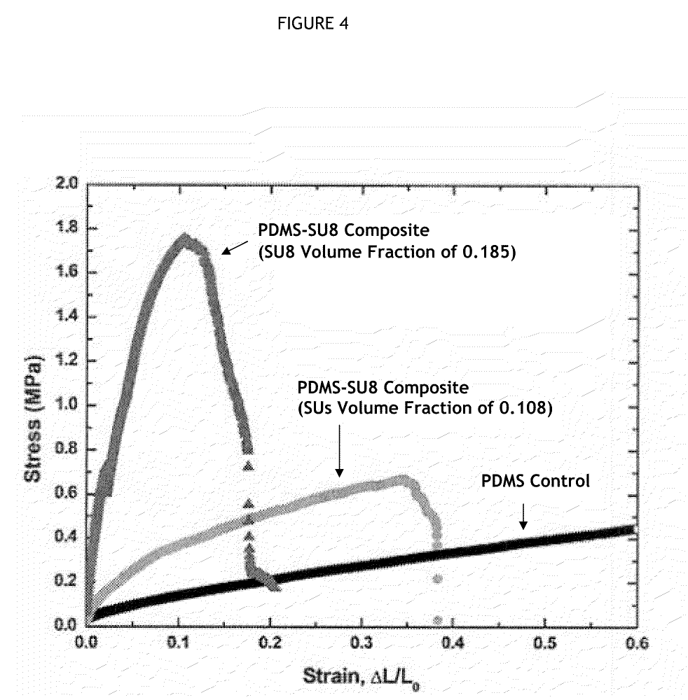

FIG. 4 shows comparative tensile strength-stress properties of the two photocured PMDS slabs having difference SU-8 volume fraction and the control PMDS slab. The photocured PDMS/SU-8 composite slabs had enhanced tensile stress-strain properties compared to the control PDMS sample.

Elastomeric Modulus Study

Four photocured PMDS slabs having different SU-8 volume fractions were prepared. The elastomeric modulus of each photocured PDMS/SU-8 composite sample was tested and compared to that of the control PDMS slab.

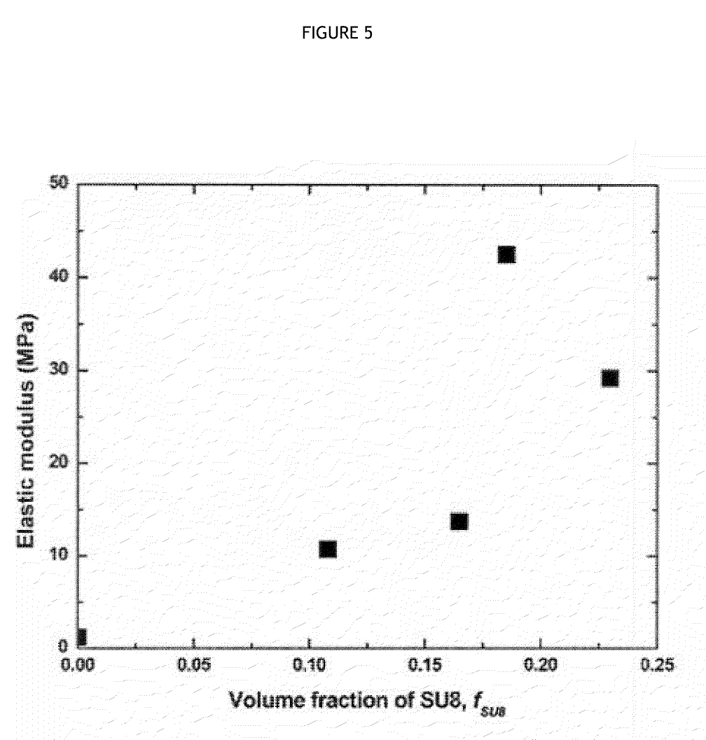

FIG. 5 shows elastomeric modulus of the slab samples as a function of the SU-8 volume fraction in the PDMS/SU-8 composite. The control PDMS slab had a SU-8 volume fraction of zero. The elastomeric modulus of the photocured PDMS/SU-8 composite slabs was higher than the control PDMS slab. Furthermore, the larger volume fraction of SU-8 embedded in the PDMS/SU-8 composite sample resulted in higher elastic modulus of the composite material. The elastomeric modulus of the PDMS/SU-8 composite sample with a SU-8 fluid volume fraction of 0.185 was about 42 times higher than to that of the control PDMS sample.

Bending Modulus Study

The modulus of bending elasticity of the elastomeric sheets was measured by Tinius-Olsen stiffness tester. The bending modulus (E_{B}) of the photocurable microfluidic structure was calculated from the slope of the initial straight line of the moment-angular deflection curve (m) and the following formulation:

$${E}_{B} = \frac{4 Sm}{w {d}^{3}}$$

wherein S is span length measured from the center of rotation of pendulum weighing system to the contact edge of the bending plate; and w and d are the width and depth of the test sample, respectively.

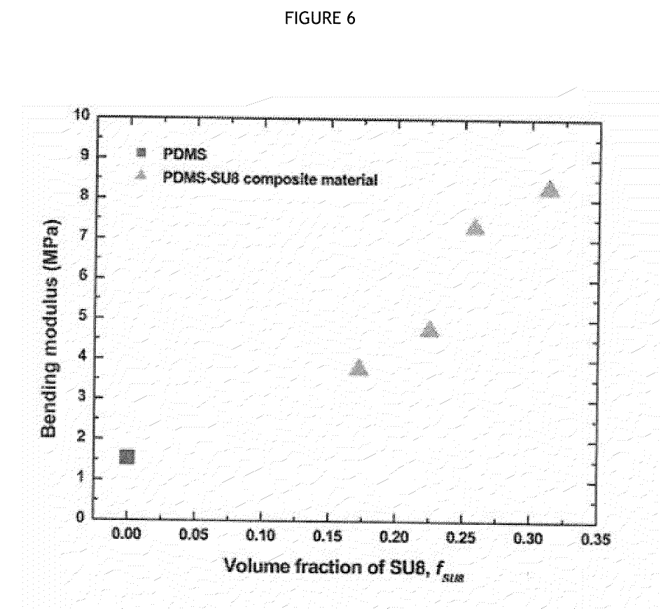

FIG. 6 shows bending modulus of the slab samples as a function of the SU-8 volume fraction in the PDMS/SU-8 composite. The control PDMS slab had a SU-8 volume fraction of zero. The photocured PDMS/SU-8 composite slabs have much higher bending modulus than the control PDMS slab. Additionally, the larger volume fraction of SU-8 embedded in the PDMS/SU-8 composite sample, the higher bending modulus of the composite material. Therefore, the photocured PDMS/SU-8 composite became stiffer and better preserving of the predetermined shape.

The experimental data indicated that the introduction of SU-8 photocurable fluidic polymer into the microfluidic channels of the PDMS slab allows retaining and recovering the programmed shape without losing the external softness and flexibility of the PDMS slab.

While the invention has been described by reference to various specific embodiments, it should be understood that numerous changes may be made within the spirit and scope of the inventive concepts described. It is intended that the invention not be limited to the described embodiments, but will have full scope defined by the language of the following claims.

We claim:

1. A photocurable microfluidic material, comprising:
(a) a flexible polymeric slab, including:
(i) a first flexible polymeric sheet with microchannel network embedded thereon;
(ii) a second flexible polymeric sheet sealed to the first flexible polymeric sheet; and
(b) a photocurable fluid in the microchannel network, the fluid being solidified upon exposure to an activated light to create a rigid endoskeleton within the slab.

2. The material of claim 1, wherein the first flexible polymeric sheet includes polydimethylsiloxane.

3. The material of claim 1, wherein the second flexible polymeric sheet includes polydimethylsiloxane.

4. The material of claim 1, wherein the second flexible polymeric sheet includes microchannel network embedded thereon.

5. The material of claim 4, wherein the first flexible polymeric sheet includes polydimethylsiloxane.

6. The material of claim 4, wherein the second flexible polymeric sheet includes polydimethylsiloxane.

7. The material of claim 4, wherein the microchannel networks embedded in the first and second flexible polymeric sheets are in an orthogonal orientation to each other.

8. The material of claim 1, wherein the photocurable fluid include a member selected from a group consisting of epoxy prepolymer, epoxy-based polymers, phenol formaldehyde polymers, polyhydroxystyrene-based polymers, dental-type polymers, and combinations thereof.

9. The material of claim 1, wherein the flexible polymeric slab further includes at least one more flexible polymeric sheet.

10. The material of claim 1, comprising:
(a) a polydimethylsiloxane slab, including:
(i) a first polydimethylsiloxane sheet with microchannel network embedded thereon;
(ii) a second polydimethylsiloxane sheet with microchannel network embedded thereon, sealed to the first flexible polymeric sheet; and
(b) a photocurable fluid in the microchannel network, the fluid being solidified upon exposure to an activated light to create a rigid endoskeleton within the slab.

11. An activated-curable microfluidic material, comprising:
(a) a flexible polymeric slab, including:
(i) a first flexible polymeric sheet embedded with microchannel network embedded thereon;
(ii) a second flexible polymeric sheet sealed to the first flexible polymeric sheet; and
(b) an activated-curable fluid material in the microchannel network, the fluid being solidified upon application of external stimuli to create a rigid endoskeleton within the slab.

12. The material of claim 11, wherein the flexible polymeric slab further includes at least one more flexible polymeric sheet.

13. The material of claim 11, wherein the first flexible polymeric sheet includes polydimethylsiloxane.

14. The material of claim 11, wherein the second flexible polymeric sheet includes polydimethylsiloxane.

15. The material of claim 11, wherein the second flexible polymeric sheet includes microchannel network embedded thereon.

16. The material of claim 15, wherein the microchannel networks embedded in the first and second flexible polymeric sheets are in an orthogonal orientation to each other.

17. The material of claim 11, wherein the activated-curable fluid include a member selected from a group consisting of electrorheologic material, magnetorheologic material, thermoplastic materials, thermoset polymeric materials, and combinations thereof.

18. The material of claim 11, wherein the external stimuli include a member selected from a group consisting of heat, electric field, magnetic field, and combinations thereof.

19. A method of producing a activated-curable material with microfluidic endoskeleton, comprising steps of:
(a) providing a first flexible polymeric sheet embedded with a microfluidic channel network;
(b) providing a second flexible polymeric sheet;
(c) bonding the first flexible polymeric with a second flexible polymeric sheet to provide a flexible polymeric slab embedded with microfluidic channel network; and
(d) introducing an activated-curable fluid into the microfluidic channel network of the slab, the fluid being solidified upon application of external stimuli to create a rigid endoskeleton within the flexible polymeric slab.

20. The method of claim 19, wherein the second flexible polymeric sheet includes microchannel network embedded thereon.

21. The material of claim 19, wherein the microchannel networks embedded in the first and second flexible polymeric sheets are in an orthogonal orientation to each other.

22. The method of claim 19, wherein the first flexible polymeric sheet includes polydimethylsiloxane.

23. The method of claim 19, wherein the second flexible polymeric sheet includes polydimethylsiloxane.

24. The method of claim 19, wherein the activated-curable fluid include a member selected from a group consisting of photocurable materials, electrorheologic material, magnetorheologic material, thermoplastic materials, thermoset polymeric materials, and combinations thereof.

25. The method of claim 24, wherein the photocurable fluid include a member selected from a group consisting of epoxy prepolymer, epoxy-based polymers, phenol formaldehyde polymers, polyhydroxystyrene-based polymers, dental-type polymers, and combinations thereof.

26. The method of claim 24, wherein the external stimuli include a member selected from a group consisting of heat, electric field, magnetic field, and combinations thereof.
